(19) United States
(12) Patent Application Publication
(10) Pub. No.: US 2025/0044184 A1
(43) Pub. Date: Feb. 6, 2025

(54) DEVICE FOR MONITORING AT LEAST ONE ANCHORING LINE FOR A FLOATING SUPPORT

(71) Applicants: NANTES UNIVERSITE, NANTES (FR); Keops Performance, CARQUEFOU (FR)

(72) Inventors: Franck SCHOEFS, Sucé Sur Erdre (FR); Jean Michel CHEVALIER, SUCÉ-SUR-ERDRE (FR); Dominique FOLLUT, ORVAULT (FR)

(21) Appl. No.: 18/835,998

(22) PCT Filed: Jan. 31, 2023
(86) PCT No.: PCT/FR2023/050120

§ 371 Date: Aug. 5, 2024

(30) Foreign Application Priority Data
Feb. 10, 2022 (FR) FR2201175

(51) Int. Cl. G01M 7/02; G08B 21/02

(52) U.S. Cl. CPC G01M 7/025; G08B 21/02

(57) ABSTRACT

The present invention relates to a device for monitoring at least one anchoring line for a floating support, characterized in that it comprises: at least one anchoring line connected to a floating support, at least one acoustic system rigidly connected to the at least one anchoring line and comprising an element, called an oscillating element, able to move between two end positions and able to come into contact with a resonant element in at least one of the two end positions, in such a way as to produce an acoustic wave upon contact of the oscillating element with the resonant element, and a system for processing the acoustic waves produced, the system being able to characterize, depending on the acoustic waves produced, normal functioning of the at least one anchoring line or defective functioning of the at least one anchoring line.

The object of the present invention is a device for monitoring at least one anchoring line for a floating support. The floating support can be, for example, a floating platform, especially an offshore platform, such as an oil platform or a wind turbine platform. In particular, the device can detect breakage, wear or deterioration of the anchoring line. The main function of a floating support's anchoring system is to hold the support in position when it is subjected to the forces of wind, current and swell.

Anchoring objects at sea remains a sensitive and delicate subject. This is all the more true when objects at sea are bulky and therefore heavy and/or sensitive to environmental conditions. As a result, a significant proportion of incidents and accidents involving platforms are linked to anchor failure. In the case of floating wind turbines, the difficulties are amplified by the use of new materials such as polyester/polyamides to reduce costs, and by the fact that a fleet of around a hundred structures must be managed, some of which have common anchoring points and some of which are unmanned, which reduces our responsiveness in the event of breakage.

In all cases, the three possibilities for anchoring line breakage are:
an accident (e.g., collision), fatigue exacerbated by biocolonization, and an extreme situation such as a storm.

Anchoring is an important and strategic issue for operators of offshore moored systems. Dedicated monitoring systems are needed to better assess the quality of these mooring lines, and above all to verify that they have not broken. All the more so as the majority of incidents occur in bad weather, making human inspection even more difficult. Breakage can be caused by wear and tear, the impact of severe conditions, or excessive stress caused by accidental impact. They can occur under difficult conditions, but they can also appear at a late stage when they have been latent for a long time. A monitoring system with alarms therefore seems particularly appropriate.

A monitoring system is known which uses tension measurements at the mooring hooks on the platform, which is advantageous for implementation and maintenance due to limited exposure to various stresses. This system, which is expensive and often tricky to install, is not very sensitive, and the weight of the mooring line itself creates a tension which can greatly interfere with the detection of a break. This detection quality is also affected by biocolonization (marine organisms, plants or animals colonizing the anchor), which can generate significant added mass at certain periods, followed by sudden changes in mass when the anchor degrades in the event of a storm.

There are also monitoring systems that take measurements along the anchoring line using tension sensors. This solution is reliable, but requires more complex implementation, as it requires the installation of a powered sensor with a cable to transmit data along the anchoring line, or a battery with an active transmission system. This adds sensitive components that need to be monitored and, more generally, reduces reliability.

The risk of cable damage or breakage is high, especially in the harsh environments mentioned above. Document DE102019103313 provides an example of an anchoring line monitoring device.

The present invention aims to overcome these disadvantages.

In particular, it offers a device for monitoring at least one anchoring line for a floating support.

The device according to the invention comprises:
at least one anchoring line, connected to a floating support,
at least one acoustic system, rigidly connected to the at least one anchoring line, and comprising an element, called an oscillating element, (and in particular an oscillating element without external energy input) able to move between two end positions and able to come into contact with a resonant element in at least one of the two end positions, in such a way as to produce an acoustic wave upon contact of the oscillating element with the resonant element, and
a system for processing the acoustic waves produced, the system being able to characterize, depending on the acoustic waves produced, normal functioning of the at least one anchoring line or defective functioning of the at least one anchoring line.

The acoustic wave processing system may be able to analyze the acoustic waves produced, and may in particular be able to compare them with reference waves characterizing normal functioning of the at least one anchoring line. The acoustic wave processing system may thus be able to characterize a faulty functioning of the at least one anchoring line in the event of a difference between the acoustic waves produced and the reference waves.

The acoustic wave processing system may be able to emit an alarm signal in the event of characterization of faulty functioning of the at least one anchoring line.

The acoustic wave processing system can comprise at least one hydrophone capable of transforming the acoustic waves produced into electrical signals.

The at least one hydrophone can be positioned under a floating support.

The acoustic wave processing system may be able to characterize normal functioning of the at least one anchoring line or faulty functioning (breakage or damage) of the at least one anchoring line depending on the frequency and/or intensity of the electrical signals. Said at least one acoustic system can be a bell comprising as oscillating element an oscillating clapper rotating inside a bell body.

Said at least one acoustic system may comprise an oscillating element capable of movement, for example in translation, between two stops acting as a resonant element. The defective functioning of the anchoring line can be a break, for example total or partial, or deterioration (e.g., loss of material (wear, corrosion, fiber breaks) or degradation of the properties of the material (e.g., loss of elasticity, elongation)) of the at least one anchoring line.

Defective functioning of the anchoring line may also result in biocolonization of the at least one anchoring line.

In the event of malfunction of the at least one anchoring line, a diver or underwater robot can be sent to work on said at least one anchoring line. More generally, inspection and repair of the at least one anchoring line can be initiated.

Further advantages and particularities of the present invention will become apparent from the following description, given as a non-limiting example and made with reference to the attached figures:

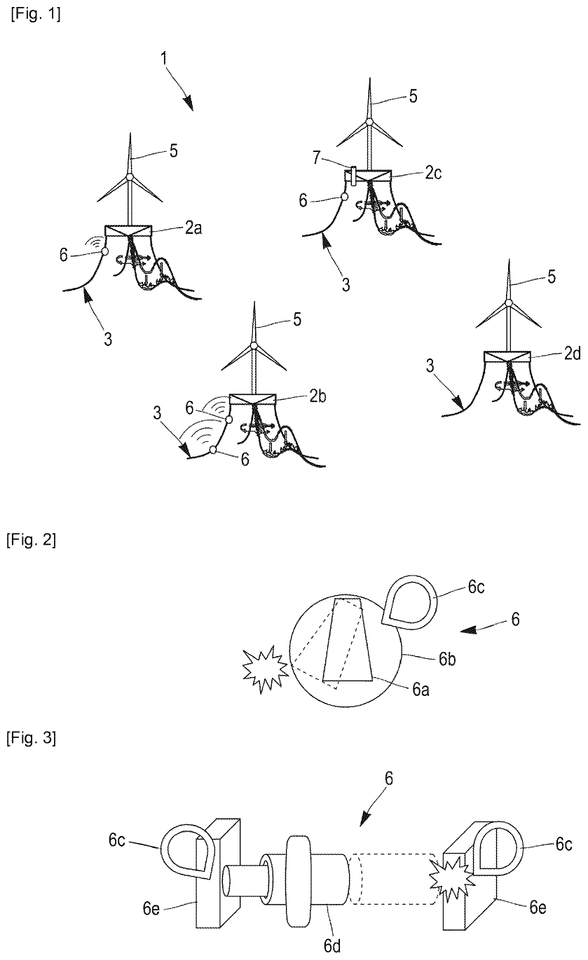

FIG. 1 is a schematic general view of floating supports equipped with a device for monitoring at least one anchoring line for a floating support according to the invention,

FIG. 2 is a schematic view of an acoustic system implemented in the monitoring device according to the invention, in accordance with a first embodiment, and

FIG. 3 is a schematic view of an acoustic system implemented in the monitoring device according to the invention, in accordance with a second embodiment.

### DETAILED DESCRIPTION

The invention relates to the field of anchoring floating supports, particularly for offshore oil applications and/or applications in the field of marine renewable energies, especially for floating supports intended for wind turbines.

As shown in FIG. 1, floating supports 2a, 2b, 2c, 2d for wind turbines 5 are each connected to an anchor via an anchoring line 3.

In accordance with the invention, at least one acoustic system 6 is arranged on the anchoring lines 3 to be monitored.

For the floating support 2a, a single acoustic system 6 is rigidly connected to the anchoring line 3. Such a configuration makes it possible to detect a malfunction of the anchoring line, such as a break in the anchoring line, above or below the acoustic system 6.

For the floating support 2b, two acoustic systems 6 are rigidly connected to the anchoring line 3. Such a configuration makes it possible to detect faulty functioning of the anchoring line above the upper acoustic system, between the upper acoustic system and the lower acoustic system, and below the lower acoustic system.

The floating support 2c is equipped with a submerged system 7 for processing the acoustic waves produced by the acoustic systems 6. The acoustic wave processing system 7 may comprise one or more hydrophones. The acoustic wave processing system 7 is preferably immersed and attached to the float, which makes it easy to maintain. Each floating support, or some floating supports, can be fitted with at least one hydrophone. Acoustic systems are preferably placed at the connection points.

An anchoring line 3 is generally made up of four components: a surface component, a first connector, a water surface component, a second connector, and a bottom component connected to a fourth connector rigidly connected to the anchor.

The device 1 for monitoring an anchoring line for a floating support according to the invention implements an oscillating system coming into contact with a resonant element, transforming this movement into a noise as would a bell attached to the mooring lines. Ringing is monitored via acoustic wave processing systems 7.

In a first embodiment, as shown in FIG. 2, the acoustic system 6 is a bell. The bell includes a hammer or clapper 6a which strikes the outer surface 6b of the bell forming a resonant element. A hooking element 6c secures the bell to the anchoring line.

In a second embodiment, the acoustic system 6 is a bar-type linear oscillator. A sliding tube 6d strikes against plates 6e. In the vertical position, all that is needed is a material denser than water.

The postulate on which this principle is based is that an acoustic system suspended from a taut mooring line oscillates and chimes, which is no longer the case when the mooring line breaks, or the chime is altered by the difference induced by the loss of tension. The aim is to place these acoustic systems on the anchoring line and identify their sounds to characterize a taut anchoring line. The absence or alteration of sounds is a probable sign of breakage, triggering an alarm.

These acoustic systems are original not only in their shape, but also in the way they are implemented, enabling them to generate a ringing sound in a specific frequency range that can therefore be isolated from the ambient background noise. In the same way, series of acoustic systems can be produced, each with its own signature (derived from the impacting material and/or geometry) so that they can be identified in isolation, enabling several lines to be tracked simultaneously and measurement points to be staggered along the same line for finer detection.

Alternatively, instead of detecting anchoring line breakage, the device according to the invention can detect anchoring line biocolonization or deterioration. In this way, the beat variation (sound recurrence) of the acoustic wave due to colonization can be used to indirectly quantify the presence and intensity (thickness-mass) of biocolonization. Indeed, biocolonization is the cause of changes in cable thickness and mass, altering their extreme loading and resistance to fatigue. It is known to be the major phenomenon influencing cable fatigue.

The device provides a non-destructive assessment of this phenomenon, without the need for diving, enabling inspection, cleaning and maintenance plans to be optimized. To this end, a database of frequency noise based on the density and thickness of the anchoring line will be created and protected. The frequency and thickness, even if uncertain, of a given species can be linked since the sites have a dominant species, which will enable the models to be updated. The design of the acoustic system (in terms of geometry and material) will favor colonization similar to that of a cable.

In this variant, a tubular acoustic system can be used with a diameter close to that of the cable (typically 30 cm) and covered with the outer layer of the cable (a protective film or braided wires).

Overall, the monitoring system offers a number of advantages:
it limits the number of sensors, since the sensors are hydrophones positioned close to the sea surface, making them easy to install and maintain,
its simplicity and the materials used make it extremely robust,
it has very little impact on the anchoring line, as it requires only one link for hooking, and can be attached to connectors without any certification problems,
its cost remains competitive in relation to the benefits provided and the stakes involved,
it adapts easily to all anchoring systems, including those already installed,
it requires no maintenance if surface biocolonization is stopped or dealt with elsewhere, the movement of the oscillating element is not affected by biocolonization either because the acoustic system is closed or because the acoustic system has a high frequency,
it requires no electricity supply along the anchoring line, and therefore no maintenance related to such electrical components.

1. A device for monitoring at least one anchoring line (3) for a floating support, characterized in that it comprises:
at least one anchoring line, connected to a floating support,
at least one acoustic system, rigidly connected to the at least one anchoring line and comprising an element, called an oscillating element, without external energy input, able to move between two end positions and able to come into contact with a resonant element in at least one of the two end positions, in such a way as to produce an acoustic wave upon contact of the oscillating element with the resonant element, and
a system for processing the acoustic waves produced, able to characterize, depending on the acoustic waves produced, normal functioning of the at least one anchoring line or defective functioning of the at least one anchoring line.

2. The device according to claim 1, characterized in that the acoustic wave processing system is able to compare the acoustic waves produced with reference waves characterizing normal functioning of the at least one anchoring line.

3. The device according to claim 1, characterized in that the acoustic wave processing system is able to emit an alarm signal in the event of a characterization of defective functioning of the at least one anchoring line.

4. The device according to claim 1, characterized in that the acoustic wave processing system comprises at least one hydrophone able to transform the acoustic waves produced into electrical signals.

5. The device according to claim 4, characterized in that said at least one hydrophone is arranged under a floating support.

6. The device according to claim 4, characterized in that the acoustic wave processing system is able to characterize normal functioning of the at least one anchoring line or defective functioning of the at least one anchoring line depending on the frequency and/or intensity of the electrical signals.

7. The device according to claim 1, characterized in that said at least one acoustic system is a bell comprising as oscillating element a clapper oscillating in rotation inside a bell body.

8. The device according to claim 1, characterized in that said at least one acoustic system comprises an oscillating element able to move in translation between two stops acting as a resonant element.

9. The device according to claim 1, characterized in that the defective functioning of the anchoring line is a breakage of the at least one anchoring line.

10. The device according to claim 1, characterized in that the defective functioning of the at least one anchoring line is biocolonization or deterioration of the at least one anchoring line.
